(19) United States
(12) Patent Application Publication
(10) Pub. No.: US 2016/0127694 A1
(43) Pub. Date: May 5, 2016

(54) MONITORING SYSTEM FOR DETERMINING NUMBERS OF CAPTURED OR KILLED LIVING CREATURES

(71) Applicant: Yu Ju Chang, Taipei Hsien (TW)

(72) Inventor: Yu Ju Chang, Taipei Hsien (TW)

(21) Appl. No.: 14/527,788

(22) Filed: Oct. 30, 2014

(51) Int. Cl. H04N 7/18; H04N 1/21; H04N 5/232; A01M 1/02; A01M 23/00

(52) U.S. Cl. CPC H04N 7/183; A01M 1/02; A01M 23/00; H04N 5/23216; H04N 1/2112

(57) ABSTRACT

A monitoring system for determining numbers of captured or killed living creatures includes at least one living-creature capture device having functions of luring, or capturing or killing living creatures; at least one camera for capturing images of the living-creature capture devices, the images including photos; an input interface unit connected to the camera for receiving the images from the camera; an operation unit performing logic operations of the system; the operation unit includes a timer for recording times for capturing images; a comparison unit for determining a number of living creatures of the image; and the comparison unit containing a sample database; and a memory unit built in a memory for storing related data of the system. The system can be realized by a specific image processing unit which is combined with a cloud structure; or by a handset; or by a computer; or by a cloud structure.

### FIELD OF THE INVENTION

The present invention relates to monitors of harmful living creatures, and in particular to a monitoring system for determining numbers of captured or killed living creatures.

### BACKGROUND OF THE INVENTION

Conventionally, many different devices for capturing or killing harmful living creatures, such as devices for capturing or killing mice, mosquito, houseflies, etc. are developed. These living creatures have their advantages and effects. Users select suitable devices for capturing or killing harmful living creatures.

However, the prior art living-creature capture devices only have the function of capturing or killing living creatures, but they cannot determine the kinds and numbers of the living creatures captured or killed. If it is needed to do so, manual calculations are used. It is time consumed and more labors are needed. Furthermore the conventional ways have no information about the effect of environments, such as temperatures, humidity, and densities of carbon dioxide, etc., to the numbers of the living creatures cared.

Therefore, there is an eager demand for a novel way to automatically determine the number of the living creatures captured or killed by a living-creature capture device and thus the user knows the effect of the living-creature capture device and the distribution of the living creatures in a monitoring environment.

### SUMMARY OF THE INVENTION

Accordingly, to improve the defects in the prior arts, the present invention provides a monitoring system for determining numbers of captured or killed living creatures, in that the number of captured living creatures captured by a living-creature capture device is calculated so that the user would know the capture result of the living-creature capture device in different times and thus the user has the information about the capturing effect. Furthermore, environment coefficients, such as temperature and humidity are also recorded with the result. The system of the present invention can be operated continuously and automatically. Furthermore the system can be realized by a specific image processing unit, a handset, a computer and a cloud serve, various forms are provides. Thereby, by the present invention, the harmful living creatures in specific environments are known by managers.

To achieve above object, the present invention provides a monitoring system for determining numbers of captured or killed living creatures, comprising: at least one living-creature capture device having functions of luring, or capturing or killing living creatures; at least one camera for capturing images of the living-creature capture devices, the images including photos; an input interface unit connected to the camera for receiving the images from the camera; an operation unit performing logic operations of the system; the operation unit includes a timer for recording times for capturing images; a comparison unit for determining a number of living creatures of the image; and the comparison unit containing a sample database; and a memory unit built in a memory for storing related data of the system.

The present invention can be realized by a specific image processing unit which is combined with a cloud structure; or by a handset; or by a computer; or by a cloud structure.

### BRIEF DESCRIPTION OF THE DRAWINGS

FIG. 1 is a block diagram showing the function blocks of the present invention.

FIG. 2 shows an arrangement about the distribution of the cameras based on the present invention.

FIG. 3 shows one mode of realizing the structure of the present invention.

FIG. 4 shows the mode of FIG. 3, while a cloud structure is contained therein.

FIG. 5 shows a handset mode for realizing the structure of the present invention based on the present invention.

FIG. 6 shows a computer mode for realizing the structure of the present invention based on the present invention.

FIG. 7 shows a cloud mode for realizing the structure of the present invention based on the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

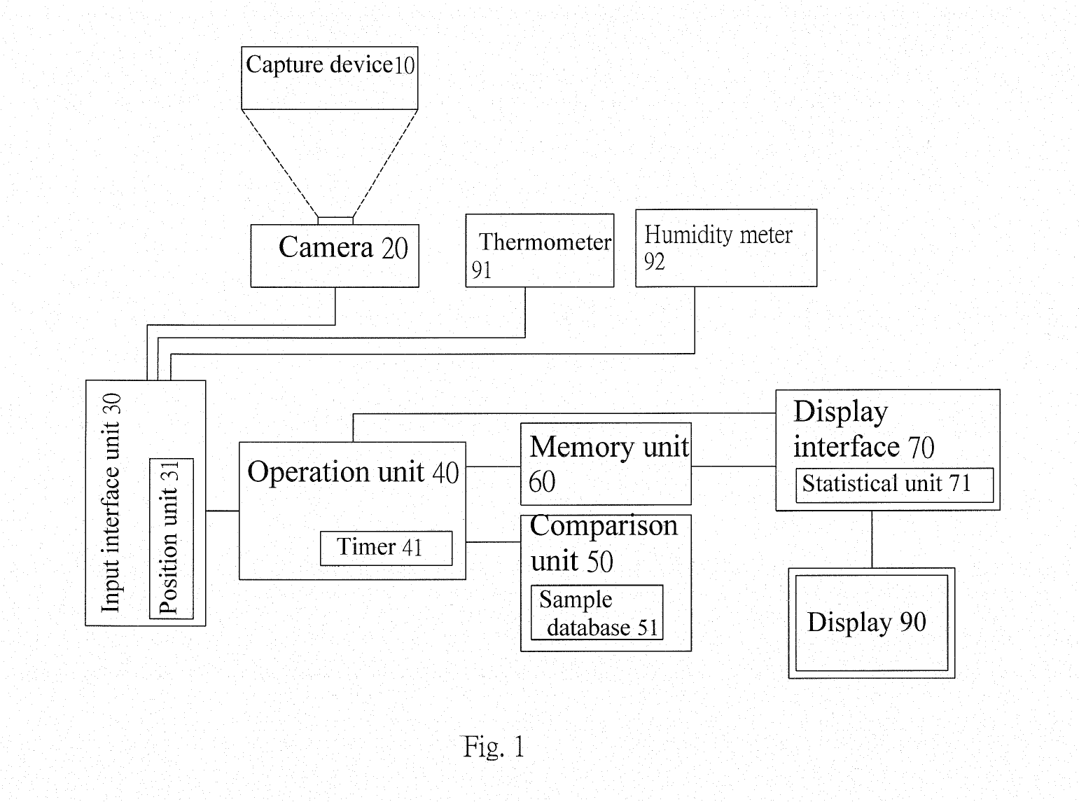

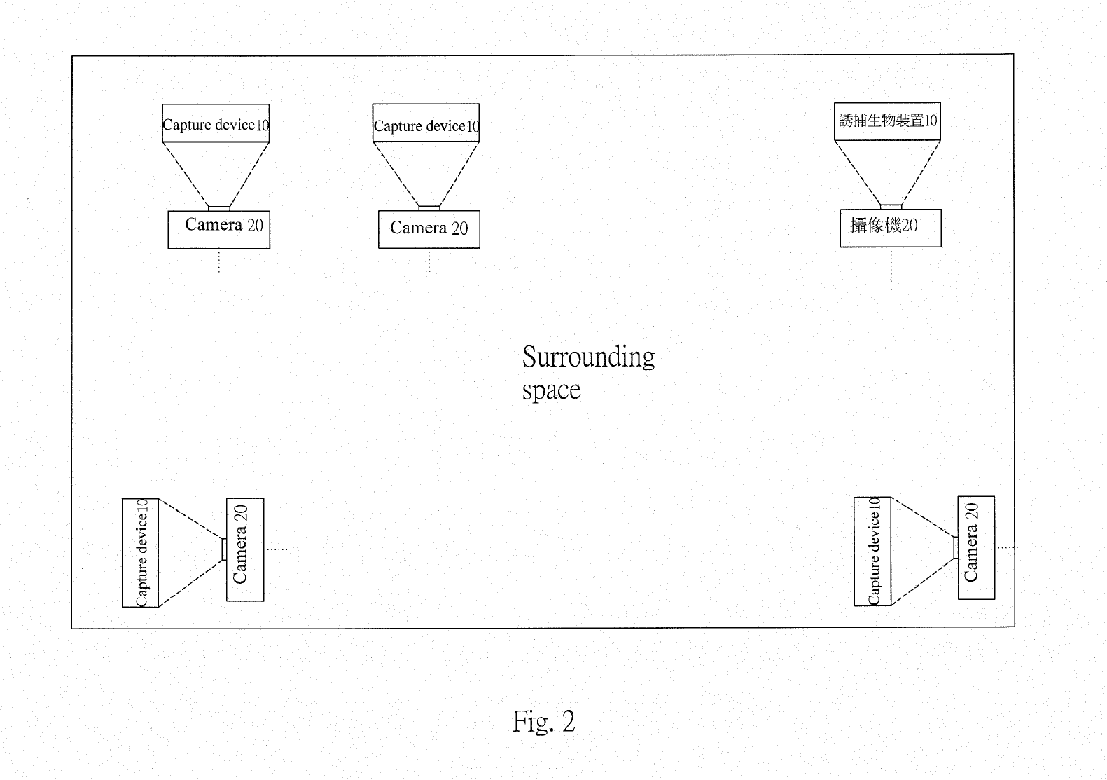

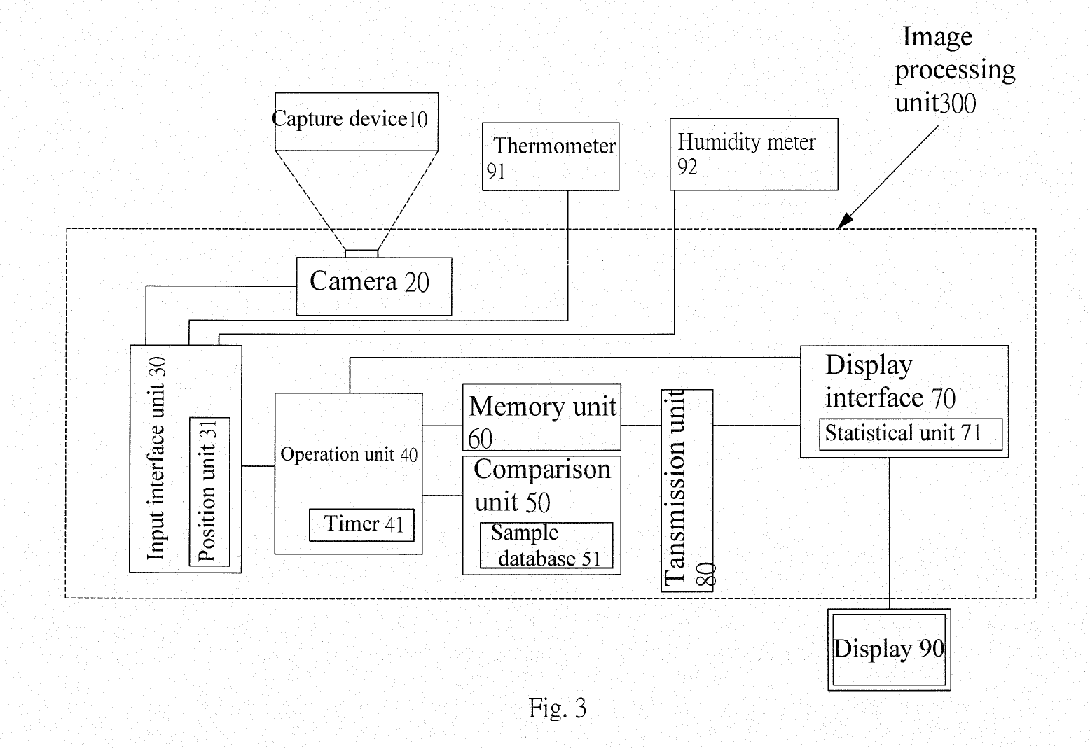

With reference to FIGS. 1 to 7, a monitoring system for determining captured or killed living creatures based on the present invention is illustrated. The present invention contains the following elements.

At least one living-creature capture device 10 (including baits contained living-creature capture device 10, luring type living-creature capture device 10, and mechanic living-creature capture device 10) has the functions to lead, lure or capture living creatures. The living-creature capture device 10 may be a time controlled device. The living-creature capture device 10 is one of a bait contained living-creature capture device, a luring form living-creature capture device and a mechanic living-creature capture device. A luring form living-creature capture device lures living creatures to enter into the living-creature capture device. The mechanic living-creature capture device captures living creatures using a mechanic device.

At least one camera 20 serves to capture images of the living-creature capture device 10 and then transfers the images (may be photos) to other devices, preferably, the transmission contains image capturing time. Preferably, the camera 20 is a time-controlled device which captures images at predetermined time period.

An input interface unit 30 is connected to the camera 20 for receiving the images from the camera 20. The input interface unit 30 contains a position unit 31 which causes the user to input positions of the cameras 20 and thus the images from the cameras 20 is transferred with the position.

An operation unit 40 performs the logic operation of the system of the present invention. The operation unit 40 includes a timer 41 for recording times in the system of the present invention.

A comparison unit 50 serves to determine a number of living creatures of an image (maybe a photo). The living creatures are predetermined living creatures which are captured by the living-creature capture device 10, such as mice, houseflies, or mosquito. The comparison unit 50 contains a sample database 51. The user can input the kind of living creature to be counted on the image and then the living creature is searched in the sample database and then by the comparing logics built in the comparison unit 50, the comparison unit 50 counts a number of the living creatures on the image, maybe the counted numbers having errors.

The sample database 51 stores features or figures of various living creature capable of being captured by the living-creature capture device 10. Thereby, by comparison the image (or a photo) with the features or figures in the sample database 51, the living creature in the image can be determined.

The environment to be captured can be equipped with a thermometer 91 or a humidity meter 92 for measuring temperatures or humidity thereof which can be transferred to the input interface unit 30.

A memory unit 60 is built in a memory which serves to store related data of the system, including numbers of living creatures on the images, images, capturing times, positions, temperatures, humidity, etc. based on capturing positions and times; and also records statistical data about these messages.

A display interface 70 has functions for displaying data in the memory unit 60. The display of data can be represented by different statistical drawings.

The display interface 70 has a statistical unit 71 for calculating statistical values about the numbers of living creatures on the images, images, capturing times, positions, temperatures, humidity, etc. so that the users can understand the variations and distributions of captured living creatures in different times, environments, temperatures, humidity, etc. The statistical value contains distributions, variations, and average values.

The present invention further comprises a display 90 for displaying the data from the display interface 70.

Furthermore a map can be built in the system of the present invention for indicating positions installing the living-creature capture device 10.

The present invention can be realized by four different modes.

### 1. Image Processor Mode:

In this mode, the camera 20, the operation unit 40 (realized by a processor), the memory unit 60, the input interface unit 30 and the comparison unit 50 are combined within an image processing device 300 so as to form as an integral structure. The image processing unit 300 further comprises a transmission unit 80 for data transmission by wired or wireless ways. The data can be transferred to a handset, a computer or a cloud server. The display interface 70 and the display 90 can also be equipped in the image processing unit 300. The image processing unit 300 is equipped in a position for capturing harmful living creatures.

Furthermore the image processing unit 90 has the function of adding identification code to a captured image so that the user can know which image processing unit capturing the image and the position of the image.

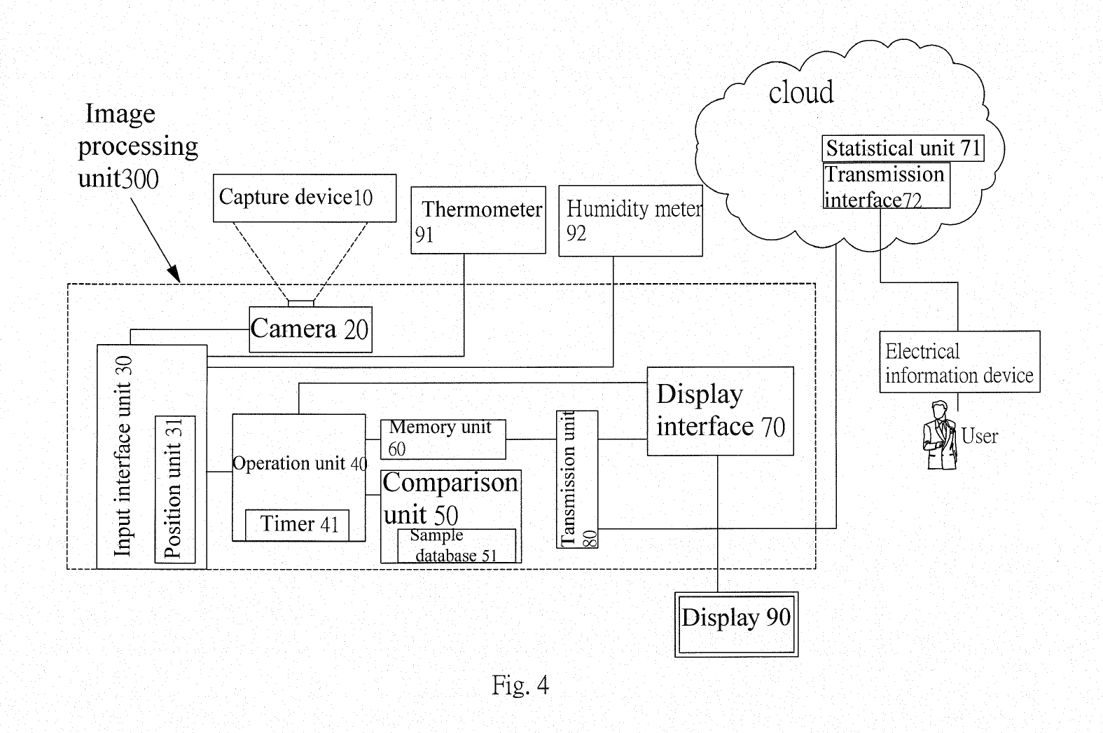

As illustrated in FIG. 4, this mode also provides a cloud structure which contains a server for receiving data from the image processing unit. The cloud servers further comprises a transmission interface 72 by which users can connect to the cloud server to get data about the result of the living-creature capture device 10.

Furthermore in this mode, the statistical unit 71 can be built in the cloud serves instead of building in the image processing unit.

### 2. Handset Mode

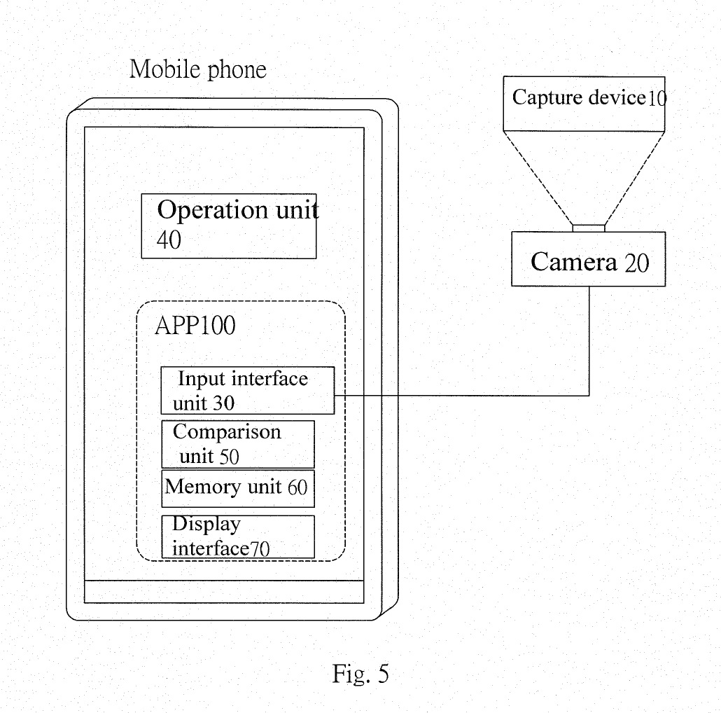

In this mode, the operation unit 40 is a processor of a handset; and the display 90 is the display of the handset. The memory unit 60, the input interface unit 30, the comparison unit 50 and the display interface 70 are combined into an APP planted into the handset. The camera 20 may be the camera 30 provided by the handset or be equipped near the living-creature capture device 10, as illustrated in FIG. 5.

### 3. Computer Mode

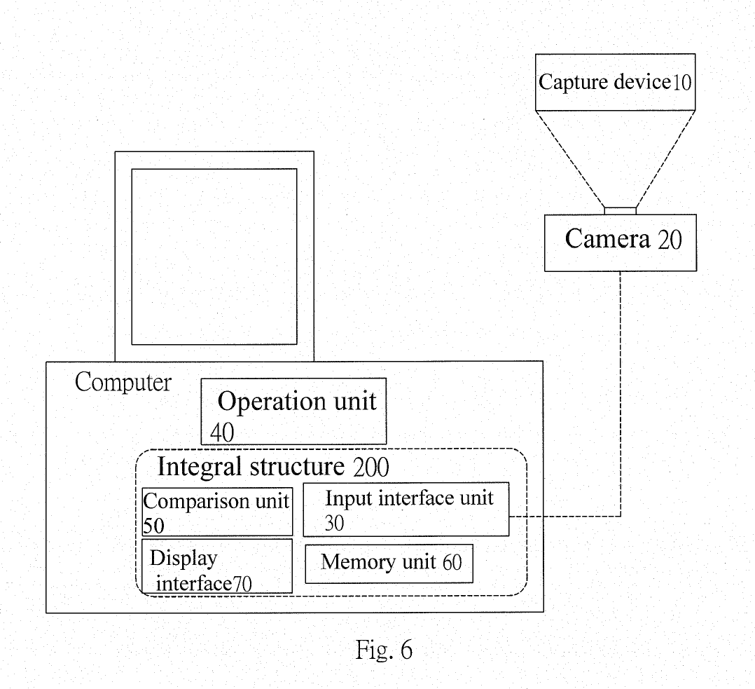

In this mode, the operation unit 40 is a processor of a computer; and the display 90 is the display of the computer. The memory unit 60, the input interface unit 30, the comparison unit 50 and the display interface 70 are combined as an integral structure 200 planted in the computer. The camera 20 is equipped near the living-creature capture device 10 and the image captured is transferred to the computer through a network, as illustrated in FIG. 6.

### 4. Cloud Mode

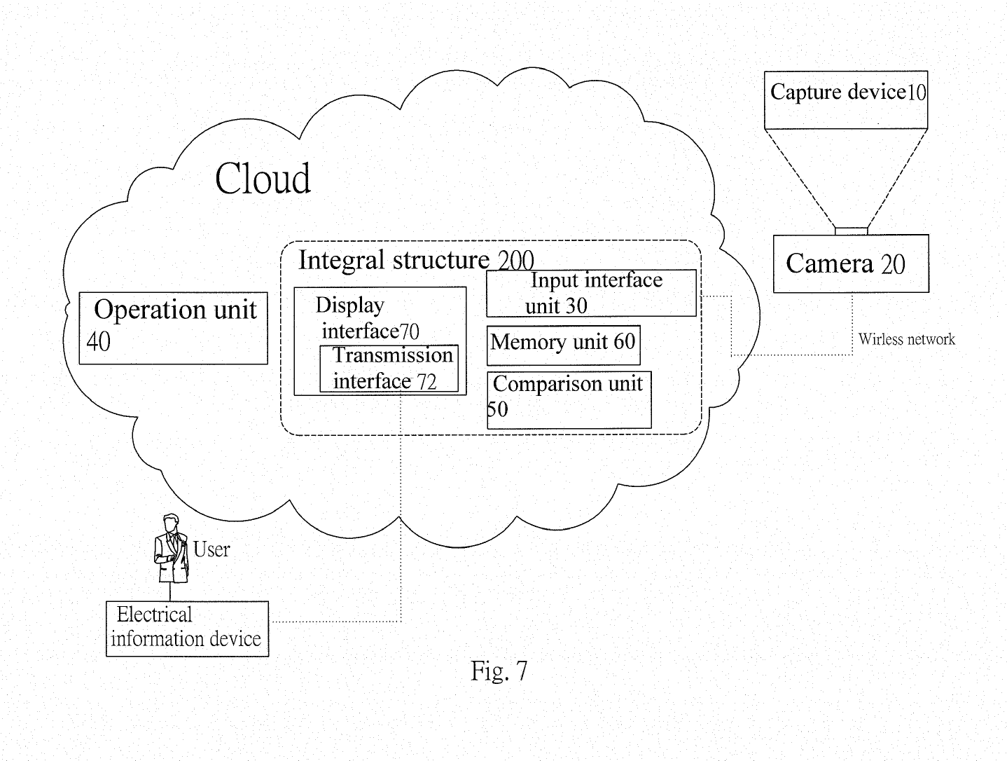

In this mode, the operation unit 40 is a processor of a serves in a cloud end. The memory unit 60, the input interface unit 30, the comparison unit 50 and the display interface 70 are combined as an integral structure 200 planted in the server. The camera 20 is equipped near the living-creature capture device 10 and the image captured is transferred to the computer through a network, as illustrated in FIG. 7.

The serves further comprises a transmission interface 72, by that a user can connect to the serves through the transmission interface 72 by using a handset or a computer for getting the data about the capturing result of the living-creature capture device 10 as illustrated in FIG. 7.

From above description of the present invention, it is known that there are many advantages in the present invention, including that the number of captured living creatures captured by a living-creature capture device is calculated so that the user would know the capture result of the living-creature capture device in different times and thus the user has the information about the capturing effect. Furthermore, environment coefficients, such as temperature and humidity are also recorded with the result. The system of the present invention can be operated continuously and automatically. Furthermore the system can be realized by a specific image processing unit, a handset, a computer and a cloud serve, various forms are provides. Thereby, by the present invention, the harmful living creatures in specific environments are known by managers.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A monitoring system for determining numbers of captured or killed living creatures, comprising:
at least one living-creature capture device having functions of luring, or capturing or killing living creatures;
at least one camera for capturing images of the living-creature capture devices, the images including photos;
an input interface unit connected to the camera for receiving the images from the camera;
an operation unit performing logic operations of the system; the operation unit includes a timer for recording times for capturing images;
a comparison unit for determining a number of living creatures of the image; and the comparison unit containing a sample database; and
a memory unit built in a memory for storing related data of the system.

2. The monitoring system for determining numbers of captured or killed living creatures as claimed in claim 1, further comprising a thermometer or a humidity meter for measuring temperatures or humidity and measured data are transferred to the input interface unit.

3. The monitoring system for determining numbers of captured or killed living creatures as claimed in claim 1, further comprising a display interface has functions for displaying data in the memory unit; and displaying of data are represented by different statistical drawings.

4. The monitoring system for determining numbers of captured or killed living creatures as claimed in claim 1, further comprising a statistical unit for calculating statistical values about the numbers of living creatures on the images, images, capturing times, positions, temperatures, humidity.

5. The monitoring system for determining numbers of captured or killed living creatures as claimed in claim 1, wherein the living-creature capture device is a bait-contained living-creature capture device.

6. The monitoring system for determining numbers of captured or killed living creatures as claimed in claim 1, wherein the living-creature capture device is a luring form living-creature capture device, which serves to lure living creatures to enter into the living-creature capture device.

7. The monitoring system for determining numbers of captured killed living creatures as claimed in claim 1, wherein the living-creature capture device is a mechanic living-creature capture device which captures living creatures using a mechanic device.

8. The monitoring system for determining numbers of captured or killed living creatures as claimed in claim 1, wherein a user inputs kinds of living creatures to be counted on the image and then the living creature is searched in the sample database and then by the comparing logics built in the comparison unit, the comparison unit counts a number of the living creatures on the image.

9. The monitoring system for determining numbers of captured or killed living creatures as claimed in claim 1, wherein the sample database stores features or figures of various living creatures capable of being captured by the living-creature capture device; thereby, by comparison the image with the features or figures in the sample database, the living creature in the image are determined.

10. The monitoring system for determining numbers of captured or killed living creatures as claimed in claim 1, wherein the input interface unit contains a position unit which causes the user to input positions of the cameras and thus the images from the cameras is transferred with the position.

11. The monitoring system for determining numbers of captured or killed living creatures as claimed in claim 3, further comprising a display for displaying the data from the display interface.

12. The monitoring system for determining numbers of captured or killed living creatures as claimed in claim 1, wherein a map is built in the system for indicating positions installing the living-creature capture device.

13. The monitoring system for determining numbers of captured or killed living creatures as claimed in claim 1, wherein the camera, the operation unit having a form of a processor, the memory unit, the input interface unit and the comparison unit are combined within an image processing device so as to form as an integral structure; and the image processing unit further comprises a transmission unit for data transmission by wired or wireless ways; and the image processing unit is equipped in a position for capturing harmful living creatures.

14. The monitoring system for determining numbers of captured or killed living creatures as claimed in claim 13, wherein the image processing unit has the function of adding identification code to a captured image.

15. The monitoring system for determining numbers of captured or killed living creatures as claimed in claim 14, further comprising a cloud structure which contains a server for receiving data from the image processing unit; the cloud servers comprises a transmission interface by which users can connect to the cloud server to get data from the living-creature capture device.

16. The monitoring system for determining numbers of captured or killed living creatures as claimed in claim 1, wherein the operation unit is a processor of a handset; and the display is a display of the handset; the memory unit, the input interface unit, the comparison unit and the display interface are combined into an APP planted into the handset; and the camera is provided by the handset or equipped near the living-creature capture device.

17. The monitoring system for determining numbers of captured or killed living creatures as claimed in claim 1, wherein the operation unit is a processor of a computer; the memory unit, the input interface unit, the comparison unit and the display interface are planted in the computer by using a hardware or a software; and the camera is equipped near the living-creature capture device and the image captured is transferred to the computer through a network.

18. The monitoring system for determining numbers of captured or killed living creatures as claimed in claim 1, wherein the operation unit is a processor of a serve in a cloud end; the memory unit, the input interface unit, the comparison unit and the display interface are combined as an integral structure planted in the server; the camera is equipped near the living-creature capture device and the image captured is transferred to the computer through a network; and
the serves comprises a transmission interface, by that a user can connect to the serves through the transmission interface by using a handset or a computer for getting the data about the capturing result of the living-creature capture device.
